(19) United States
(12) Patent Application Publication
(10) Pub. No.: US 2004/0133631 A1
(43) Pub. Date: Jul. 8, 2004

(54) Communication system

(76) Inventors: David A. Hagen, Southern Pines, NC (US); Rick Stefanik, Pinehurst, NC (US)

Correspondence Address: SMITH MOORE LLP, P.O. BOX 21927, GREENSBORO, NC, 27420, US

(21) Appl. No.: 10/337,155

(22) Filed: Jan. 6, 2003

(51) Int. Cl. G06F 15/16

(52) U.S. Cl. 709/203

(57) ABSTRACT

A communication system and method that provides efficient, global load balancing and enables data transfer over the internet without being blocked by firewalls an proxies. The system includes a plurality of remote portals that place requests and receive responses. A request is sent to a plurality of gateway servers. The first gateway server to respond, considering any performance delays, is selected to process the request. The request is then passed to a plurality of routers. The first router to respond, considering any performance delays, processes the request and converts it into a response. The response is sent back to the gateway server and then to the portal. Data is transferred between the portals using a transport module which is a client interface that establishes connections between portals, a transport channel that is an application interface that transmits timely data, and proxy that assists the transport module in bypassing firewalls.

### BACKGROUND OF THE INVENTION

1. Field of the Invention

The present invention is directed towards a multimedia communication system that facilitates real time data transfer over the internet without being blocked by firewalls and proxies and provides efficient, global load balancing.

2. Description of the Related Art

Gatelinx, Corp., assignee of the present invention, has proposed several systems, methods, and apparatuses for improving sales to potential consumers through a number of portals, such as stationary kiosks, set top boxes, portable kiosks, desktop computers, laptops, handheld computers, and personal digital assistants. These inventions are disclosed in application Ser. Nos. 09/614,399 for NETWORK KIOSK, 09/680,796 for SMALL FOOTPRINT NETWORK KIOSK, 09/750,954 for INTERACTIVE TELEVISION FOR PROMOTING GOODS AND SERVICES, 09/842,997 for METHOD TO ATTRACT CONSUMERS TO A SALES AGENT, and 09/873,034 for BACKEND COMMERCE ENGINE. The present invention is directed towards a network communication system that transports data and processes requests, which may be used as the underlying communication system for these portals.

When data packets are transferred over the internet using prior art networks, the data is generally transferred over HTTP or HTTPS. Sometimes, however, data is transferred that does not have the appearance of being standard html, text, and graphic data. Receipt of this non-standard data may be blocked by firewalls that are implemented by the receiving network to keep the network secure. When such blocking occurs, real time transfer of the data is obviously inhibited.

Another problem associated with data transport over a network, such as the network utilized for the inventions described above, is that when requests are generated from multiple clients or portals on the network, all of the requests are sent to one central server that is load balanced. That central server then segments the requests among all of the servers in its cluster. The problem is that the central device cannot receive an infinite number of connections. Rather, the central device can become overloaded with requests and all of the client requests are still sent to that one central server which may reside on one or many redundant networks. Thus, there is no way to manage and direct network traffic on a large scale.

Accordingly, there is a need in the art for a communications system that enables real time transfer of data over the internet without regard to firewalls and proxies. There is a further need in the art for a communications system that provides for efficient, global load balancing.

### SUMMARY OF THE INVENTION

The present invention solves this need by providing a communication system including a plurality of remote portals on a network that are adapted to generate requests and receive responses, and a plurality of gateway servers on the network that are adapted to accept requests from the plurality of portals, wherein when a portal request is transmitted from a portal in the plurality of remote portals to the plurality of gateway servers, a performance level of each gateway server in the plurality of gateway servers is ascertained. The time it takes for a gateway server to respond to the portal request is delayed as the performance level of the gateway server degrades, any response delay of a gateway server is decreased as its performance level improves, and each gateway server rejects requests if its performance level has reached a predetermined minimum. The first gateway server in the plurality of gateway servers that responds the portal request, considering any performance delays, is selected to process the portal request and a connection is established between them. The portals may consist of stationary kiosks, portable kiosks, desktop computers, laptops, handheld computers, set-top boxes, and personal digital assistants.

The system further includes a plurality of routing sites on the network including a plurality routers for processing the portal request. The gateway server that is selected to process the portal request determines which routing site the request indicates should process it and transmits the portal request to the plurality of routers in that routing site. When attempting to connect to a router, a performance level of each router in the selected routing site is ascertained. The time it takes for a router to respond to the portal request is delayed as the performance level of the router degrades, any response delay of a router is decreased as its performance level improves, and each router rejects requests if its performance level has reached a predetermined minimum. The first router in the plurality of routers that responds the portal request, considering any performance delays, is selected to process the portal request as the primary router. The primary router receives connection attempts from the plurality of routing sites until the primary router becomes overloaded with requests. When the primary router becomes overloaded with portal requests, the primary router is configured to refuse additional portal requests and a new primary router is selected to process the portal requests. The primary router processes the portal request as a series of jobs, which may be handler jobs, server jobs, database jobs, and web server jobs.

After processing the portal request, the primary router changes the request into a response that is transmitted back to the selected gateway server. The selected gateway server then transmits the response to the requesting portal and the requesting portal closes the connection.

The present invention further includes a method for providing efficient load balancing in a network including the steps of generating a portal request from a remote portal on a network, transmitting the portal request to a plurality of gateway servers on the network, ascertaining a performance level of each gateway server in the plurality of gateway servers that receive said portal request, delaying the response time of a gateway server as its performance level degrades, decreasing any response delay of a gateway server as its performance level improves, rejecting requests to a gateway server if its performance level has reached a predetermined minimum, selecting the gateway server that first responds to the portal request, considering any performance delays, to process the portal request, and establishing a connection between the requesting portal and the gateway server that selected to process the portal's request.

The present invention further provides a system for transporting data between portals including a transport module that establishes connections between at least two portals and coordinates data transfer over multiple channels, a transport channel that transmits the data and ensures that the data is timely transmitted, and a proxy that assists the transport module in bypassing firewalls when transmitting the data. Preferably, the transport module utilizes only outbound connections to the proxy to simulate HTTP traffic. The proxy matches incoming connections from the transport modules of the at least two portals so that the data can be transmitted between the portals, however, a connection is preferably established between the two portals by attempting to connect the at least two portals both peer-to-peer and through the proxy. If the peer-to-peer connection is successful, any proxy connection is dropped in favor of the peer-to-peer connection. A proprietary transport port is provided for use when attempting connections between the two portals. When the proprietary port is blocked, a connection is attempted using an HTTP port. When the HTTP port is used, the data is wrapped with HTTP headers to simulate standard HTTP traffic and avoid firewalls.

In one embodiment, when attempting to make a connection, the transport module attempts to connect to a plurality of target applications on the managed transport system. The time it takes for a target application to respond to the transport module may be delayed and a connection is established between the transport module and the first target application to respond to the transport module, considering any delays. In an alternative embodiment, the transport module attempts to connect to a plurality of target applications ranked in order of priority. The time it takes for a target application to respond to the transport module may be delayed and a connection is established between the transport module and the highest ranked target application that responds to the transport module within a predetermined time, considering any delays.

Once a connection is established between the two portals, two socket connections to the same IP address are created and maintained such that one connection is assigned to incoming data and the other connection is assigned to outgoing data. Data is sent over the transport channel using send data, which is data that is guaranteed to be transmitted, and/or stream data, which is data that is dropped in favor of more recently transmitted data so that the data is continually sent without regard to transmission rate. The stream data is stamped with a time-to-live (TTL) setting that sets a time limit on when the stream data expires and the send data is stamped with a TTL setting of zero indicating that send data never expires. Both the send data and stream data are queued in the transport module until the transport module is ready to send the data. The transport module monitors a total available bandwidth of the multiple channels and maximizes usage of the bandwidth if all of the channels are not using their share. The multiple channels take turns inserting data into the transport module according to their bandwidth allotment. The transport module checks the TTL settings to determine whether the data is still valid for transmission and transmits the data if it is valid and discards the data is it has expired. In an alternative embodiment, in predetermined intervals, the data from the multiple channels is combined to create a single data packet that is compressed, encypted, and transmitted. When the HTTP port is used to transmit the single data packet, the single data packet is sent as binary encoded data but fails over to text encoded data if necessary. Also, when an HTTP port is used to transmit the single data packet, the data packet is wrapped with HTTP headers to simulate standard HTTP traffic and avoid firewalls.

When the transport module receives data, any HTTP headers are stripped, any encrypted data is decrypted, and any compressed data is decompressed, the data from the multiple channels is sent to the respective destination channels, each destination channel reassembles its partial data into the original data packet, and the data is returned to an application using that channel. Preferably, the transport module continually transmits data between connected portals so the transport module can identify failed connections and attempt to repair failed connections.

### BRIEF DESCRIPTION OF THE DRAWINGS

The present invention is better understood by a reading of the Detailed Description of the Preferred Embodiments along with a review of the drawings, in which:

FIG. 1 is a block diagram of the communication system of the present invention.

FIG. 2 is a flowchart of an exemplary embodiment of a method by which the present invention works.

FIG. 3 is a block diagram of the managed transport system of the communication system of the present invention.

### DETAILED DESCRIPTION OF THE PREFERRED EMBODIMENTS

The illustrations and examples discussed in the following description are provided for the purpose of describing the preferred embodiments of the invention and are not intended to limit the invention thereto.

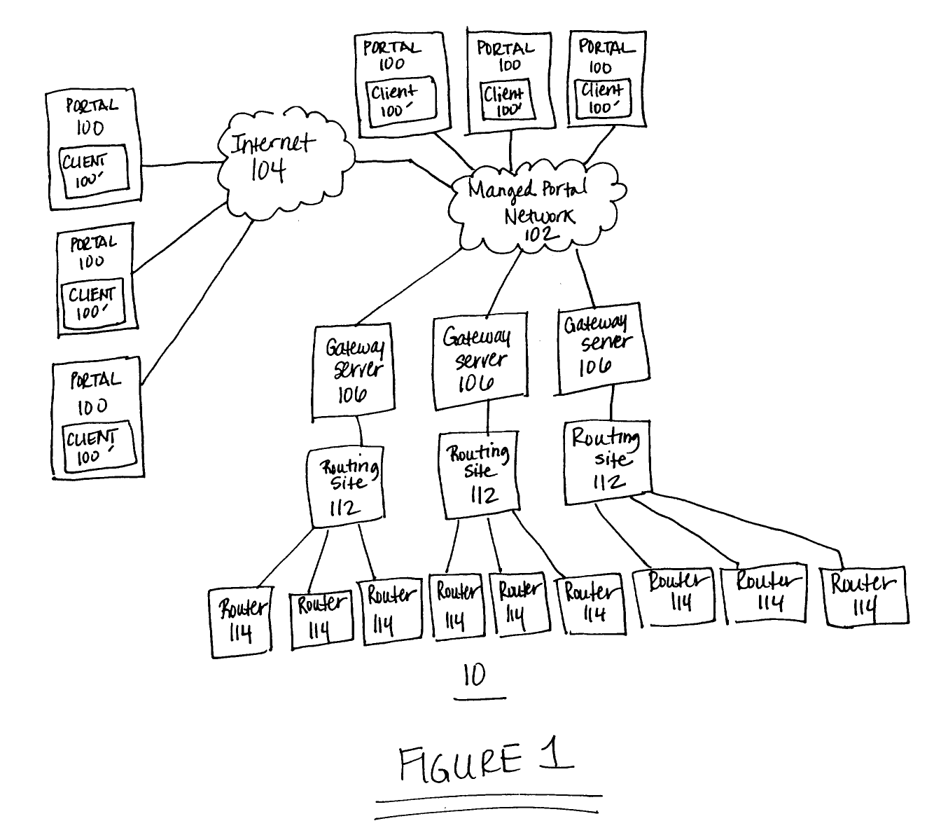

The present invention is directed towards a multimedia communication system that enables real time transfer of data over the internet. This communications transport allows software developers to open managed conduits of information, referred to herein as channels, between two or more portals. Specifically, the communications transport of the present invention allows for peer to peer (p-to-p) and client/server communication while providing the benefits of encryption, compression, and firewall penetration. These features cannot be achieved with prior art methods of data transmission. To this end, a network must be in place to allow communication over the internet between plurality of portals. Such a network is illustrated in FIG. 1, referenced generally by communication system 10.

Communication system 10 may include a managed portal network 102 operated by a service provider operating according to the present invention, although this need not be the case. Managed portal network 102 interfaces with the Internet 104 and particularly with the world wide web. A plurality of portals 100 may be connected directly to the managed network 102, indirectly through an Internet service provider, or through some other medium. The portals 100 of the present invention may comprise computers that may reside in the form of stationary kiosks, portable kiosks, desktop computers, laptops, handheld computers, set-top boxes, and personal digital assistants, for example. By using an advanced routing and data transport system, as discussed in more detail below, the various portals 100 can place requests to and receive requests from one another. Thus, the communication system 10 of the present invention provides an infrastructure that is robust, scalable, and ready for enterprise use.

To aid in describing the communication system 10 of the present invention, an example of a kiosk that requests to initiate a multi-media conference call is used throughout this description. It should be understood, however, the present invention is not limited to this particular application. Rather, an infinite number of applications and requests may be utilized in accordance with the present invention.

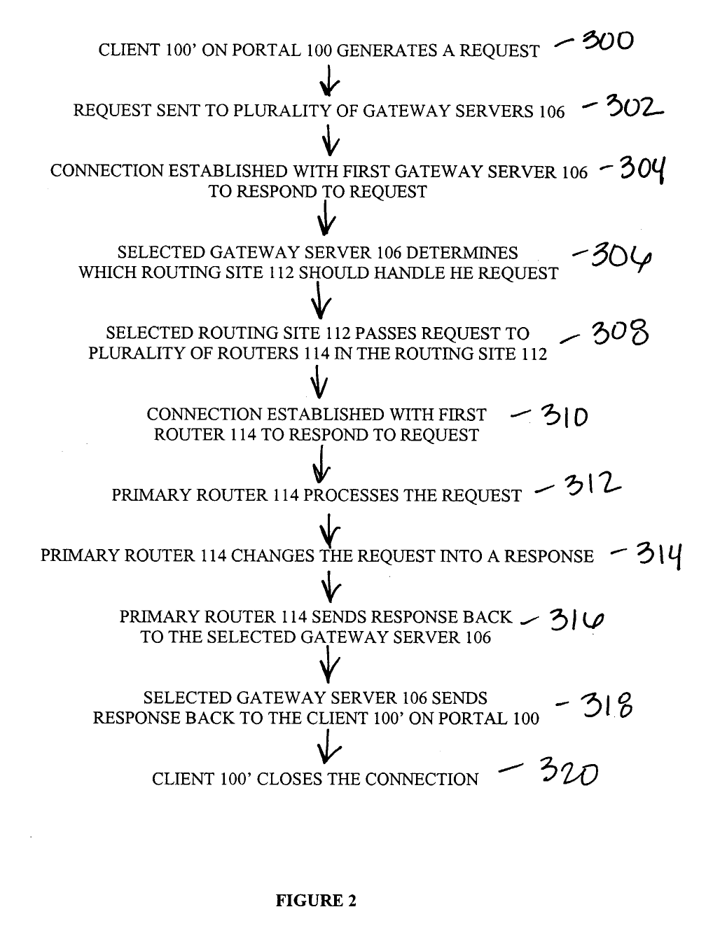

As illustrated in the flowchart of FIG. 2, the data transfer process of the present invention commences when a request is generated from a portal 100 via an application interface, which is referred to herein as a client 100′ (step 300). In the kiosk example, this may occur when a customer in a store approaches the kiosk and touches the screen or button to initiate a conference call with a remote sales agent. At that point, a request is generated from the portal 100 to initiate a call. Once the request is generated by the client 100′, the client 100′ attempts to connect to a plurality of servers on the network, which are referred to herein as gateway servers 106 (step 302).

The plurality of gateway servers 106 on the network 102 are available to accept requests from the plurality of clients 100′. These gateway servers 106 comprise logical switches that operate as a central routing site and serve as the entry point into the system 10. The client 100′ requests, which vary in number and in timing, attempt to connect to several gateway servers 106 at one time, however, the gateway servers 106 assist the clients 100′ with selecting the best one by varying their response to incoming requests. Particularly, each gateway server 106 is configured to sleep before responding to a request as its performance level degrades. Correspondingly, each gateway server 106 is configured to decrease its response delay as its performance level improves. Each gateway server 106 is further configured to reject connections if its performance level reaches critical levels. The closest gateway server 106 to the client 100′ is contacted by the client 100′ based on its connection time but the best performing gateway server 106 is selected by adding the performance delay to that connection time. Therefore, the client 100′ connects to the closest, best performing gateway server 106, which is the first gateway server 106 to respond to the request (step 304). The system 10 accordingly provides efficient, global load balancing.

Once communication is established between the gateway server 106 and the client 100′, the gateway server 106 preferably passes the request to a plugin manager for filtering before processing the message. The plugin manager is used to allow request and response filters to be easily added to the gateway server 106. These filters are run as the input and output pass through the gateway server. The input is processed when a request first arrives and the output is processed when a response is returned from a router 114, which is described in detail below.

After the request is run through the plugin manager, the gateway server 106 processes the request to determine which routing site 112 the request indicates should process it (step 306). If the gateway server 106 does not recognize the routing site 112 associated with the request, the request is denied. On the other hand, if the gateway server 106 recognizes the routing site 112, the gateway server 106 determines whether that routing site 112 has a corresponding list of routers 114 available. If the routers 114 are not available, the request is denied. If the routers 114 are available, the gateway server 106 passes the request to a selected router 114 in that routing site 112 for processing, as discussed in more detail below. The system 10 is preferably configured so that the gateway server 106 requests a new list of routing sites 112 and corresponding routers 114 that are on the network 114 from the central routing site in the gateway server 106 in predetermined intervals, such as every twenty-four (24) hours. This allows newly added routers 114 to be recognized by the gateway servers 106 and ultimately used to process requests. In addition, this periodic refreshing allows the central routing site to route its requests to multiple routing sites 112, while maintaining control and logging over all requests.

When a request is sent to the plurality of routers 114 in the selected routing site 112 (step 308), a single router 114 is selected to process the request by a method similar to that used when selecting the gateway server 106. Particularly, the routing site 112 maintains a list of IP addresses for all of its routers 114 and attempts to maintain connections with one or more of those routers 114. When a new router 114 is needed, the routing site simultaneously attempts to connect to multiple routers 114 and the first router 114 to respond (taking into account performance delays) is utilized (step 310). This router 114 is referred to as the primary router 114. Thus, the routing sites 112 utilize the load balancing technique discussed above to select the closest, best performing router 114.

The primary router 114 continually receives connection attempts from many routing sites 112 as the routing sites 112 seek a new primary router 114 with good performance. Therefore, the primary router 114 is used until it becomes overloaded with requests. When the primary router 114 becomes overloaded, it is configured to reject connections if necessary, and command any or all of its routing sites 112 to stop sending requests to decrease the router's 114 load. At this point, the routing sites 112 consider the router 114 to be in cleanup mode and requests already submitted to that router 114 are completed before the connection to that router 114 is dropped. However, each time the primary router 114 indicates it can't receive any more requests, the routing site 112 selects a new primary router 114.

The routers 114 are responsible for processing requests as a series of jobs (step 312). These jobs may contact handler servers, databases, and web servers, for example, or may modify contents of the request. Referring again to the kiosk conferencing example, the router may examine information from the kiosk, select the company to contact based on the owner/lessee of the kiosk, and select the one or more individuals that are to receive the conference call based on the company's routing pattern.

The router 114 begins its processing of the request by creating a job queue for the request and adding the default job to this job queue. The default job is the same for all requests, but returns the jobs specific to the request type received. All jobs are represented by XML and are processed in a sequential manner except that any jobs returned by a job replace that returned job in the XML structure.

An infinite number of job plugins may be developed as plugins to process requests in accordance with the present invention. The jobs discussed below are merely exemplary of the types of jobs that can be created.

A database job indicates a stored procedure to call on a specific database. The parameters for that stored procedure may be provided with specific values or an indication of where in the request the router 114 can acquire the value to pass. The results of the database job are in XML and may define one or more jobs that are to be inserted into the job queue. Output parameters may also be used to modify the original request. An additional form of a database job is a bulk insert job. This job uses a separate data type definition to open a persistent connection to a database and insert many rows of data simultaneously. This is especially useful when handling request logging and proxy logging requests from the gateway servers 106.

A handler job indicates a handler server IP address and a message to be sent to that server. The result of a handler job is a reply with a modified message and an indication of success or failure. For successful returns, any output parameters in the message are modified in the original request. If exclusivity is set in the handler job, the reply from only one handler out of each concurrent batch is accepted. If an acknowledge is defined in the handler job, each accepted reply is acknowledged, which may be in the form of a defined message with contents. A handler job may also indicate if the successful completion of that job should cause the response to be returned to the client 100′ or if the router 114 should continue to process subsequent jobs.

Referring again to the types of jobs handled by the routers 114, a modify job, unlike some other jobs, does not provide external access. Rather, it provides specific changes to be made to the request. Each modify job adds or modifies specific nodes or attributes to the request. Output parameters may also be used to modify the request, but the modify job can be used to modify the contents at a specific point in the job sequence.

HTTP jobs contact an HTTP web server and retrieve the contents of specified URLs. The contents returned are added to the request in a specific location.

Restart, continue and return are commands that direct the router 114 to take specific job queue actions. These are not handled through plugins because they handle the actual job queue processing. Restart flushes the job queue and restarts with the initial job(s) but uses the current state of the request. Continue simply proceeds with the next job in the queue. Return indicates that the current request should be returned to the gateway server 106. If the end of the job queue is reached, this automatically results in a return job.

After creating a job queue for the request and adding the default job to this job queue, the router 114 eventually changes the message type from a “request” to a “response” (step 314). The router 114 may also append load distribution specific information to the response. The response may then be passed back to the gateway server 106 (step 316), which may use plugins to filter the response. Once the response filters have been processed by the plugin manager 110, the gateway server 106 passes the response back to the client 100′ on the portal 100 (step 318).

In a preferred embodiment, the routers 114 retrieve a list of blocked IP addresses for each request type directly from the database. Therefore, when a router 114 receives a subsequent request from a gateway server 106, it can ascertain the IP address of the client 100′ sending the request and determine whether that IP address is excluded from processing by that router 114. If the IP address is excluded, the request is denied and returned to the client 100′. An error message may be attached to the returned request.

In a preferred embodiment, the gateway servers 106 periodically request an updated list of nearby gateway servers 106 and a list of gateway servers 106 closest to that gateway 106 is generated. A predetermined number of those gateway servers 106 is selected and returned to the client 100′ for use when the next request is made. The updated list of gateways 106 may also contain a flag indicating that the gateway server 106 should test proximity. The gateway server 106 then determines its proximity to other gateway servers 106 on the network in an automated fashion by testing its connection time to every other gateway server 106. These connection times are forwarded to the central routing site 112 and stored in the database for use in distributing updated lists.

The list of IP addresses provided by the gateway server 106 to the client 100′ with the response allows for the distribution of new gateway servers 106 quickly and easily. It also allows the system to provide other gateway servers 106 in the same general area of the internet topology. Since the topological distance from the client 100′ to the gateway server 106 also affects gateway server 106 response time, the simultaneous connection to many gateway servers 106 causes the client to connect to gateway servers 106 increasingly close to the client 100′. This process is referred to as a “drunken walk” since each repetition may cause the successful gateway server 106 to be a step closer to (but possibly further away from) the client 100′. Since the gateway servers 106 are selected based on response time, the tendency over many repetitions is to select the best performing gateway server 106 that is closest to the client 100′. This list of gateway servers 106 is received with each response, as discussed above, and stored in memory or stored in a flat file on each client 100′.

Once the response has been returned to the client 100′ and the connection is closed by the client 100′ (step 320), the request is considered complete. The request's source and destination information is then logged using a bulk insert library. Specifically, the request is persisted to file and then sent to the router as a request that results in a bulk insert job. The gateway server 106 sends a bulk insert job to the router 114 when this file reaches a predetermined size or age.

In summary, every request from a client 100′ that is received by a router 114 contains a request type that indicates how that request should be processed. Once the job queue is complete or a return job is encountered, the request becomes a response and is returned back to the gateway server 106 and then to the client 100′. As applied to the kiosk example referenced above, when the router 114 has selected a group of individuals that may satisfy the kiosk's request, the router 114 contacts the “queue” server into which each sales agent has logged on. The queue server contacts the recipient agent's computer and notifies it of the request from the kiosk. The agent can either accept or reject the call. If the agent declines, the handler declines to the router and the next agent's queue in the list is contacted. If the agent accepts, the response includes connection information that is passed to the router 114, then to the gateway server 106, and then to the kiosk. Once the response is passed back to the kiosk, the kiosk and the agent computer attempt to initialize communication with each other via encrypted high speed networking to form a conference. This is done through a managed transport system.

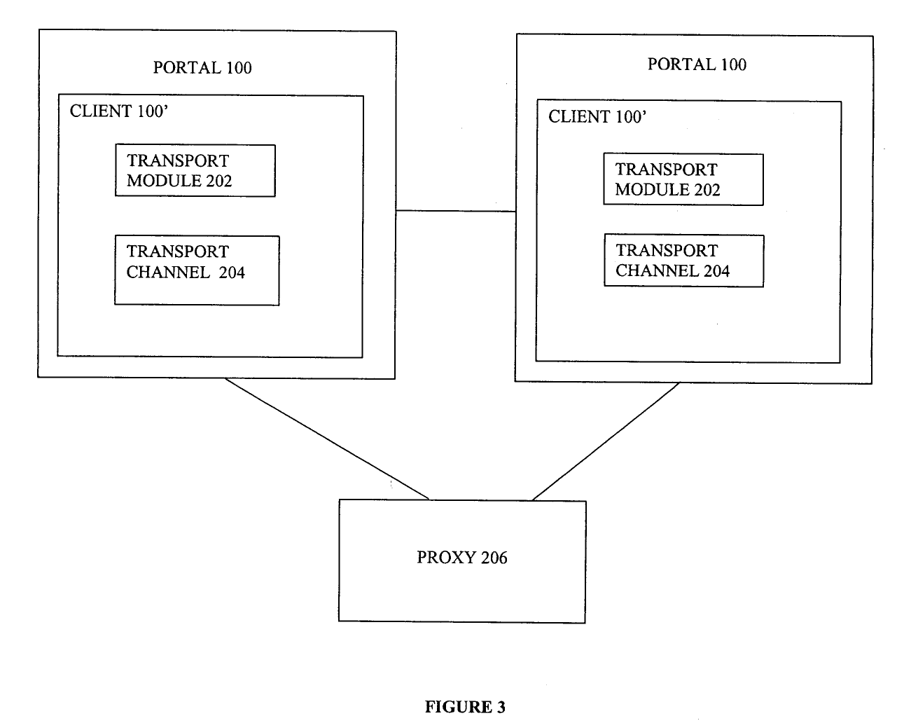

Referring now to FIG. 3, the managed transport system 200 of the present invention that enables data transfer between portals 100 generally comprises three parts: a transport module 202; transport channel 204; and proxy 206. The transport module 202 is client software that establishes connections and receives data from various channels. Specifically, the transport module 202 coordinates data from the many channels and ensures that the data is reliably and securely transmitted to the remote portal 100. The transport module 202 also manages the data in ways that make the transmission of live communication over the internet possible without utilizing TCP/IP features such as UDP, multicast, etc., which are typically blocked by firewalls. The transport module 202 further determines the best method for transmitting data to ensure that the data can bypass firewalls and proxies.

The transport channel 204 is the application interface for sending data to the remote portal 100. In particular, the channel 204 allows for the queuing of data to be transmitted. The transport channel 204 also assists the transport module 202 in ensuring that real-time data is transmitted in a timely manner. Channel identifiers are negotiated between the two portals 100 communicating over the transport system 200, and new channel identifiers are requested from the transport system 200 through an API call.

The transport module 202 uses the proxy 206 to assist in bypassing firewalls and proxies. By utilizing only outbound connections to a mutually available proxy 206, the transport module 202 is able to simulate standard HTTP traffic, thereby making filtering or blocking of the data virtually impossible. The proxy 206 matches incoming connections from two transports and relays data between the two connections. In a preferred embodiment, the proxy 206 is located on the same physical machine as the gateway server 106. This ensures that the client 100′ has access to this proxy 206 and the proxy is the closest to the client 100′. The data sent over the proxy 206 is then logged by the gateway server 106 and sent to the central routing site on the gateway server 106 for storage.

The managed transport system 200 establishes a preferred connection to the remote portal 100 by simultaneously connecting to the proxy and peer-to-peer (p-to-p). When connecting through the proxy 206, both portals 100, 100 connect to the proxy 206 and data is relayed between them. If both the proxy and p-to-p connections are available, the proxy connection is dropped in favor of the p-to-p connection. If only one is available, this methodology allows for transmission of data to begin as quickly as possible. The proxy 206 can accept connections for multiple applications on one server.

The managed transport system 200 preferably uses a proprietary managed transport port for maximum efficiency. In firewall situations, however, this proprietary port is often blocked. In these cases, a connection is attempted using the HTTP port as an additional alternative. In the cases where the HTTP port has to be used, the binary and text encoded data is wrapped with HTTP headers to get around the firewalls.

The managed transport system 200 may be configured to allow an application to attempt connections and listen for incoming connections. Each application utilizing the system 200 to listen for incoming connections may be configured to tell the system 200 to delay its response to the request based on a plurality of factors, such as performance level, as discussed above with respect to the routers 114 and gateway servers 106. When the managed transport system 200 is used to place outgoing connections, multiple connection attempts are simultaneously sent to multiple target applications running on the managed data transport system 200. A connection is established with the first application to respond to the request, considering any sleep delays. In an alternative embodiment, the managed transport system 200 establishes a connection with the first application to respond on a prioritized list of applications within a predetermined period of time.

Once a successful connection method is established, the managed transport system 200 preferably creates and maintains two socket connections to the same IP address, one being used for incoming data (reader) and the other being used for outgoing data (writer). This method is more efficient than using full duplex connections. The pair of socket connections forms a session via which data is exchanged. Multiple channels can be created for each distinct data transmission. This allows multiple processes or applications to send and receive data independently over one connection.

Once a proxy 206 or p-to-p connection has been established to the remote portal 100, data is sent through the channel 204 using either stream-data or send-data. Stream-data allows data to be sent in a manner resembling UDP by selectively dropping data that is unable to be transmitted quickly enough. By using a time-to-live (TTL) setting on each data packet, the managed transport system is able to drop data in favor of more recent real-time data so that stream-data can be continually sent without regard for the outbound transmission rate. The receiving side can be set to buffer streamed data based on acceptable delay, maximum buffer size, or acceptable loss rate. The packet feed rate can be set to ensure that data is received at a steady rate regardless of incoming data rates and jitter. These settings allow the channel to manage live data despite fluctuations in bandwidth and connection speed.

Send-data, as opposed to stream-data, is used to send guaranteed data (or G-Data) and is always transmitted. This type of transmission is less efficient than stream-data and is comparable to TCP/IP, which guarantees the delivery of data and that no data will be lost during the transmission. The transport channel 204 blocks during the G-Data sending phase to ensure the prior data packet has been transmitted before accepting additional data to be sent. No settings apply to send-data since all data must arrive at the receiving side as quickly as possible.

Data sent via stream-data or send-data is queued within the transport channel. These data packets are stamped with a TTL stamp and the current TTL setting (this is 0 for G-Data indicating data that the packets should never be dropped due to TTL). Data stays queued in the transport channel 204 until the transport module 202 is ready to send that data. This is determined by available bandwidth and management of all the channels participating in that conference. This bandwidth equalization prevents all the channels sent over the same session from becoming locked or slowed because one channel is transmitting a large amount of data. Specifically, the transport module 202 allows each channel to utilize only its portion of the total available bandwidth, but always maximizes usage of the bandwidth if some channels are not utilizing their share. The channels take turns inserting data into the transport module 202 according to their allotment. As the transport module 202 receives data from the transport channel 204, it checks the TTL settings on that data to ensure this data is still valid for transmission. Expired data is discarded so the most current data is transmitted in a real time scenario.

In an alternative embodiment, data is taken from many channels to create a single transmission packet (or frame). At a set time interval, such as 25 ms, the data gathered from channels is transmitted to the remote computer. This data framing naturally causes the data to be sent and received at a steady rate, which is critical to reduce jitter in real time communication. TTL headers are removed and headers are added to the data packet indicating the destination channel. By acquiring data from the channel queue in a round-robin manner, the data is fragmented from its original form and recombined into data-frames not to exceed a specified size and time limit. This ensures that data is sent at a steady rate and that data is sized optimally for compression and encryption. The data frames are then compressed using real time binary compression. This compression does not affect performance and can result in transmission improvements, even on previously encrypted or compressed data. The data is also preferably encrypted using 256-bit encryption, however, the encryption can be required, preferred, or disabled. Preferred encryption utilizes encryption if it can be established, but allows an un-encrypted data transmission if it cannot.

The transport module 202 takes special precautions when sending data through a proxy over HTTP. Since this traffic must simulate standard web transactions, each data packet is sent as binary encoded but generally fails over to become text encoded if necessary. Random HTTP headers are added to match the form of data being sent. This gives data the appearance of being standard html, text and graphic data.

When data arrives at the remote transport module 202, it is stripped of any HTTP headers, decrypted and decompressed. The partial data from many channels is then removed from the data-frame and spliced to their respective destination channels. As each channel receives data fragments, it queues that data and re-assembles the partial packets into the original packet that was sent into the transport channel 204. Once the original packet is re-assembled, this data is returned to the application utilizing that channel 204.

The transport module 202 continually transmits “pulse” data between the two connected portals 100. This allows the managed transport system 200 to identify a failed connection immediately. The system 200 will attempt to repair individual failed connections for a few seconds by attempting new replacement connections, but if this timeout is exceeded, the connection is terminated and all channels are notified. The managed transport system 200 also provides channel-specific performance information upon request to any channel. These statistics can be used in tuning each individual channel to best utilize the available throughput. In addition, these statistics may be supplied to the controlling application.

Certain modifications and improvements will occur to those skilled in the art upon a reading of the forgoing description. By way of example, the present invention is not limited to a kiosk application. Rather, the communication system of the present invention may be utilized by any type of portal 100 that facilitates communication. Also, the portal 100 requests are not limited to conferencing requests. Rather, an infinite number of requests may be processed in accordance with the present invention, such as login, update server, and any other database transactions. All such modifications and improvements of the present invention have been deleted herein for the sake of conciseness and readability but are properly within the scope of the following claims.

What is claimed is:

1. A communication system comprising:
a plurality of remote portals on a network that are adapted to generate requests and receive responses; and
a plurality of gateway servers on the network that are adapted to accept requests from the plurality of portals;
wherein when a portal request is transmitted from a portal in the plurality of remote portals to the plurality of gateway servers, a performance level of each gateway server in the plurality of gateway servers is ascertained;
wherein the time it takes for a gateway server to respond to the portal request is delayed as the performance level of the gateway server degrades;
wherein any response delay of a gateway server is decreased as its performance level improves;
wherein each gateway server rejects requests if its performance level has reached a predetermined minimum;
wherein the first gateway server in the plurality of gateway servers that responds the portal request, considering any performance delays, is selected to process the portal request; and
wherein a connection is established between the requesting portal and the gateway server that is selected to process the request.

2. The system of claim 1 wherein the remote portals are selected from the group consisting of stationary kiosks, portable kiosks, desktop computers, laptops, handheld computers, set-top boxes, and personal digital assistants.

3. The system of claim 1 further comprising a plugin manager comprising at least one filter that filters the portal request before the request is processed by the selected gateway server.

4. The system of claim 1 further comprising a plurality of routing sites on the network comprising a plurality routers for processing the portal request, wherein the gateway server that is selected to process the portal request determines which routing site the request indicates should process it and transmits the portal request to the plurality of routers in that routing site.

5. The system of claim 4 wherein the selected gateway server requests an updated list of routing sites and corresponding routers in predetermined intervals.

6. The system of claim 4 wherein each router in the plurality of routers retrieves a list of blocked IP addresses for each portal request type so that when a router receives subsequent requests from a gateway server, the router can ascertain the IP address of the requesting portal and deny the request if the IP address is blocked.

7. The system of claim 4 wherein:
a performance level of each router in the selected routing site is ascertained;
the time it takes for a router to respond to the portal request is delayed as the performance level of the router degrades;
any response delay of a router is decreased as its performance level improves;
each router rejects requests if its performance level has reached a predetermined minimum; and
the first router in the plurality of routers that responds the portal request, considering any performance delays, is selected to process the portal request as the primary router.

8. The system of claim 7 wherein the primary router receives connection attempts from the plurality of routing sites until the primary router becomes overloaded with requests.

9. The system of claim 8 wherein when the primary router becomes overloaded with portal requests, the primary router is configured to refuse additional portal requests and a new primary router is selected to process the portal requests.

10. The system of claim 7 wherein the primary router processes the portal request as a series of jobs.

11. The system of claim 10 wherein the jobs are selected from the group consisting of handlers, servers, databases, and web servers.

12. The system of claim 10 wherein job plugins are developed to process the jobs.

13. The system of claim 7 wherein after processing the portal request, the primary router changes the request into a response that is transmitted back to the selected gateway server.

14. The system of claim 13 wherein the selected gateway server transmits the response to the requesting portal and the requesting portal then closes the connection.

15. The system of claim 14 wherein the selected gateway server receives a list of other nearby gateway servers on the network and a predetermined number of the nearby gateway servers on the list is transmitted to the requesting portal with the response.

16. The system of claim 15 wherein in predetermined intervals, the selected gateway server tests its connection time to a plurality of other gateway servers on the network and the connection times are used to generate the list of nearby gateway servers that is transmitted to the requesting portal.

17. The system of claim 1 further comprising a bulk insert library that stores a portal request's source and destination information.

18. A method for providing efficient load balancing in a network comprising the steps of:
generating a portal request from a remote portal on a network;
transmitting said portal request to a plurality of gateway servers on the network;
ascertaining a performance level of each gateway server in the plurality of gateway servers that receive said portal request;
delaying the response time of a gateway server as its performance level degrades;
decreasing any response delay of a gateway server as its performance level improves;
rejecting requests to a gateway server if its performance level has reached a predetermined minimum;
selecting the gateway server that first responds to the portal request, considering any performance delays, to process the portal request; and
establishing a connection between the requesting portal and the gateway server that is selected to process the portal request.

19. The method of claim 18 further comprising the step of transmitting the portal request from the selected gateway server to a plurality of routers on the network.

20. The method of claim 19 further comprising the steps of:
ascertaining a performance level of each router in the plurality of routers that receive the portal request;
delaying the response time of a router as its performance level degrades;
decreasing any response delay of a router as its performance level improves;
rejecting requests to a router if its performance level has reached a predetermined minimum;
selecting the router that first responds to the portal request, considering any performance delays, to process the portal request as a primary router; and
transmitting the portal request to the primary router.

21. The method of claim 20 further comprising the step of the primary router processing the portal request as a series of jobs.

22. The method of claim 20 further comprising the steps of the router:
processing the portal request and changing the request into a response; and
transmitting the response back to the selected gateway server.

23. The method of claim 22 further comprising the steps of:
the selected gateway server testing its connection time to a plurality of other gateway servers on the network; and
utilizing the connection times to generate an updated list of nearby gateway servers to the requesting portal;
transmitting the updated list of nearby gateway servers to the requesting portal with the response.

24. A managed data transport system for transporting data between portals on a managed portal network comprising:
a transport module that establishes connections between at least two portals and coordinates data transfer over multiple channels;
a transport channel that transmits the data and ensures that the data is timely transmitted; and
a proxy that assists the transport module in bypassing firewalls when transmitting the data.

25. The system of claim 24 wherein the transport module utilizes only outbound connections to the proxy to simulate HTTP traffic.

26. The system of claim 24 wherein the proxy matches incoming connections from the transport modules of the at least two portals so that the data can be transmitted between the portals.

27. The system of claim 26 wherein a connection is established between the at least two portals by attempting to connect the at least two portals both peer-to-peer and through the proxy.

28. The system of claim 27 wherein if the peer-to-peer connection is successful, any proxy connection is dropped in favor of the peer-to-peer connection.

29. The system of claim 24 further comprising a proprietary transport port that is used for attempting connections between the at least two portals.

30. The system of claim 29 wherein when the proprietary port is blocked, a connection is attempted using an HTTP port.

31. The system of claim 30 wherein when the HTTP port is used, the data is wrapped with HTTP headers to simulate standard HTTP traffic and avoid firewalls.

32. The system of claim 24 wherein once a connection is established between the at least two portals, two socket connections to the same IP address are created and maintained such that one connection is assigned to incoming data and the other connection is assigned to outgoing data.

33. The system of claim 24 wherein data is sent over the transport channel using send data, which is data that is guaranteed to be transmitted, and/or stream data, which is data that is dropped in favor of more recently transmitted data.

34. The system of claim 33 wherein the stream data is stamped with a time-to-live (TTL) setting that sets a time limit on when the stream data expires and the send data is stamped with a TTL setting of zero indicating that send data never expires.

35. The system of claim 33 wherein send data and stream data are queued in the transport module until the transport module is ready to send the data.

36. The system of claim 35 wherein the transport module monitors a total available bandwidth of the multiple channels and maximizes usage of the bandwidth if all of the channels are not using their share.

37. The system of claim 36 wherein the multiple channels take turns inserting data into the transport module according to their bandwidth allotment.

38. The system of claim 35 wherein the transport module:
checks the TTL settings to determine whether the data is still valid for transmission;
transmits the data if the data is still valid; and
discards the data if the data has expired.

39. The system of claim 24 wherein in predetermined intervals, the data from the multiple channels is combined to create a single data packet that is compressed and transmitted.

40. The system of claim 39 wherein the single data packet is encrypted before it is transmitted.

41. The system of claim 39 wherein when an HTTP port is used to transmit the single data packet, the single data packet is sent as binary encoded data but fails over to text encoded data if necessary.

42. The system of claim 39 wherein when an HTTP port is used to transmit the single data packet, the data packet is wrapped with HTTP headers to simulate standard HTTP traffic and avoid firewalls.

43. The system of claim 39 wherein when the transport module receives data:
any HTTP headers are stripped, any encrypted data is decrypted, and any compressed data is decompressed;
the data from the multiple channels is sent to the respective destination channels;
each destination channel reassembles its partial data into the original data packet; and
the data is returned to an application using that channel.

44. The system of claim 24 wherein the transport module continually transmits data between connected portals so the transport module can identify failed connections and attempt to repair failed connections.

45. The system of claim 24 wherein:
the transport module attempts to connect to a plurality of target applications on the managed transport system;
the time it takes for a target application to respond to the transport module may be delayed; and
a connection is established between the transport module and the first target application to respond to the transport module, considering any delays.

46. The system of claim 24 wherein:
the transport module attempts to connect to a plurality of target applications ranked in order of priority;
the time it takes for a target application to respond to the transport module may be delayed;
a connection is established between the transport module and the highest ranked target application that responds to the transport module within a predetermined time, considering any delays.
